(19) United States
(12) Patent Application Publication
(10) Pub. No.: US 2012/0180924 A1
(43) Pub. Date: Jul. 19, 2012

(54) Flat-Running Device for an Automobile, Mounted Assembly Including Same and Related Mounting/Removal Method

(75) Inventors: Stéphane Auvray, Verderonne (FR); Eric Carpentier, Champagne Sur Oise (FR); Patrick Clement, La Boissiere en Thelle (FR)

(73) Assignee: HUTCHINSON, Paris (FR)

(21) Appl. No.: 13/392,812

(22) PCT Filed: Sep. 3, 2010
(86) PCT No.: PCT/IB10/53978

§ 371 Date: Apr. 4, 2012

(30) Foreign Application Priority Data
Sep. 8, 2009 (FR) 09 04261

(51) Int. Cl. B60C 17/04; B23P 11/02

(52) U.S. Cl. 152/520; 29/894.3

(57) ABSTRACT

The present invention relates to a flat-running device intended for being fitted on an assembly mounted on a tubeless one-piece rim for an automobile, said mounted assembly including said device, and to a method for mounting and/or removing said mounted assembly. The device according to the invention (1) includes a ring (2) with a radially internal mounting surface for the device, intended to closely match the hollow section of the rim (11), the ring having an open structure with two ends held closely facing one another by a means (5) for clamping the ring. According to the invention, at least one transverse notch (6), the two edges and the bottom of which are located under one of the ends of the ring, is formed in at least one of said side portions (3a), forming a circumferential lip which projects axially from the corresponding side wall of the ring, which includes said recess and is suitable for wedging the ring in the hollow section of the rim, such as to enable, via said notch, transverse insertion of a tool (7) such as a lever between the rim and said mounting surface in order to facilitate the operations of mounting and/or removing the device on the rim.

The present invention relates to a run-flat device intended to be fitted to a mounted assembly of the tubeless type with a one-piece rim for a motor vehicle, such a mounted assembly incorporating this device and allowing the vehicle to cover a significant distance at a relatively high speed when the mounted assembly is partially or fully deflated, and to a method of mounting and/or removing this mounted assembly.

For a one-piece rim, known run-flat devices generally consist of a rigid support ring which is mounted tightly around a wheel rim inside a tire. This ring is, for example, formed either as a single piece with relatively flexible side walls that may be continuous, or alternatively as an open flexible piece (i.e. a split piece, from which a slice has been removed), or as at least two rigid pieces in the form of circular arcs or sectors.

Documents FR-A1-2 755 905 and WO-A1-2008/132348, both in the name of the applicant company, each disclose a run-flat device for a one-piece rim with circumferential rim well, of the ring type which may be a split ring, and which on the one hand has a radially internal mounting face capable of espousing the axial profile of the rim well and, on the other hand, a radially external support face intended to support the tire under run-flat conditions.

In the known way, such a mounted assembly is assembled using a tire-fitting machine which turns the assembly composed of the rim, the run-flat ring and the tire about the axis of symmetry of the rim. During this assembly, the split ring has to pass over the lateral rim flanges in order finally to become wedged in the rim well. As for the removal of the split ring from the rim, that is done in the opposite way by levering this ring over the rim flange.

One major disadvantage with these steps of mounting/removing split-ring run-flat devices is that during mounting, this ring does not always turn at the same as time as (i.e. does not rotate as one with) the rim and the tire, and this may make this mounting awkward, and also, extracting the ring from between the rim flanges may present a number of difficulties.

It is an object of the present invention to propose a run-flat device configured to be fitted to a tubeless mounted assembly for a motor vehicle which comprises a one-piece wheel rim with a circumferential rim well and a tire mounted on the rim, the device being configured to support the tire following a drop of inflation pressure inside the mounted assembly, and which overcomes the aforementioned disadvantages. This device comprises a ring which has a mounting face that is radially internal to the device and intended to espouse the axial profile of the rim well, this mounting face having two lateral portions, the ring having an open structure with two ends held facing one another close together by ring-clamping means.

To this end, a run-flat device according to the invention is such that at least one transverse notch, the two edges and bottom of which are located short of one of the ring ends, is formed in at least one of said lateral portions, which lateral portion(s) form(s) a circumferential notched lip that projects axially with respect to the corresponding side wall of the ring, this lip exhibiting said at least one notch and being configured to wedge the ring in the rim well, so as to allow a lever-type tool to be inserted transversely via this notch between the rim and this mounting face to assist with the operations of mounting the device on the rim and/or removing it therefrom.

What is meant here by a “notch” is a small nick that serves to butt the ring against the rim via the insertion of this tool, this nick being, by definition, a cut made on this radially internal lateral portion of the ring with the removal of material, and which is such that the spacing between the two edges of the notch corresponds substantially to the width of the tool inserted between these edges.

Advantageously, said edges of said or of each notch or nick may run substantially in the axial direction, and said bottom connecting these edges together may run substantially in the circumferential direction, so that the or each notch is substantially in the shape of a crenel, preferably a trapezoidal crenel.

According to one embodiment of the invention, said or each notch runs transversely over just part of the axial width of said radially internal mounting face so as at that location to form a recess that is both transverse and radial for only that lateral portion of the ring that forms said notched lip.

According to a variant embodiment of the invention, said or each notch runs transversely over the entire axial width of this mounting face so as at that location to form a recess that is both transverse and radial for each of the two lateral portions of the ring.

It will be noted that this variant with an axially through-notch has the advantage of assisting still further with the operation of removing the device by inserting the lever-type tool.

According to another preferred feature of the invention, said or at least one of said notches is situated in the immediate vicinity of one of the ends of the ring, which assists still further with the aforementioned mounting/removal operations.

By way of an even greater preference, that edge of that notch which is adjacent to one of the ends of the ring is separated from that end by a non-nicked end section of said lateral portion which in the circumferential direction is of a length shorter than that of this notch.

According to another feature of the invention, the ring may be formed as a single piece, said at least one lip being crenellated by said or each notch and designed to wedge the ring in said rim well via its being mounted pressing against the two side walls of this well.

According to one embodiment of the invention, the ring may have a radially external support face which is configured to support the tire under run-flat conditions, and which thus defines the run-flat device according to the invention, which is then a one-piece split device. It will be noted that, as a variant, this ring could form just a radially internal part of a run-flat device according to the invention, a radially external part of which would then support the tire and for example could be made of another split ring.

Advantageously, this ring may be made of a plastic (for example based on a thermoplastic polymer such as a polyamide), an elastomer (preferably a compact, i.e. non-cellular, elastomer, such as a commonplace rubber or a thermoplastic elastomer for example) or even a composite, it being emphasized that this ring has to be able to absorb the shocks of driving both under inflated and under run-flat conditions. In addition, this ring has on the one hand to have enough flexibility that it can be mounted on the rim by being slipped over the rim flanges after having been inserted inside the tire and, on the other hand, has to have enough rigidity that it remains correctly positioned in the bottom of the rim well during the mounting.

According to another feature of the invention, this ring may exhibit at least one circumferential radial indentation, and said ring-clamping means may comprise at least one annular clamping band which circumferentially encircles the ring at this indentation, (this band being radially set back from said support face) and which is provided with a clamping and locking connector system, so as to bring said ring ends closer to one another and keep the ring substantially in contact with the rim under running conditions.

It will be noted that this mounting of the or each clamping band set back from the support face of the ring notably allows this ring to be held on the rim while effectively opposing the phenomenon whereby the ring is “spun-out” when driving in the inflated state, while at the same time protecting the or each band by ensuring that it does not interfere with the tire under run-flat conditions.

Advantageously, when viewed in axial section, the ring may substantially be in the shape of a U defining this indentation in the form of a groove accommodating said clamping band, which may comprise a metal collar which is clamped and locked preferably by a screw mounted in journals. It will be noted that this metal collar or band has to be flexible enough that it can easily be inserted into the tire, and substantially undeformable with respect to the loads transmitted during running once the band has been locked in position, in order effectively to oppose the aforementioned “spinning out” phenomenon.

As a variant, the or each clamping band may be of the closed strap type made of fabric and of adjustable diameter, for example.

It will also be noted that the mechanism used to clamp or tighten the or each band can be used both in the plane of the wheel and, more advantageously, on an axis perpendicular to this plane (something which is less restrictive for mounting).

It will be further noted that said ring may advantageously be provided with an annular elastic tie in the bottom of the or of each indentation, this elastic tie being intended to hold the ring in the rim well and being surmounted by the clamping band.

A tubeless mounted assembly for a motor vehicle according to the invention comprises a one-piece wheel rim with a circumferential rim well, a tire mounted against axially internal and external flanges of the rim and a run-flat device mounted on the rim and configured to support the tire following a drop in inflation pressure inside the mounted assembly, and it is characterized in that the device is a device as defined hereinabove.

According to another feature of the invention, said radially internal mounting face of the ring may be mounted pressing against this rim well via said circumferential-lip-forming lateral portion crenellated by said or each notch.

A method of mounting a run-flat device as defined hereinabove on a one-piece wheel rim with two, axially internal and external, flanges and/or of removing it therefrom, involves inserting a lever-type tool radially between said rim well and said radially internal mounting face of the ring at the location of said or of at least one of said notch(es):
when mounting the device and the surrounding tire on the rim in order, thanks to this tool inserted in this way, to immobilize this device on the rim so as to lever it over the rim flanges and ensure that it rotates as one with the rim and with the tire in this rim well when a machine for assembling the mounted assembly is turning it about the axis of the rim; and/or
when the device is being removed from the rim so as, thanks to this tool inserted in this way, to assist with extracting the device from the rim well and with levering it beyond the corresponding rim flange to make it easier to take it off the rim.

Other features, advantages and details of the present invention will become apparent from reading the following description of one exemplary embodiment of the invention, given by way of nonlimiting illustration, said description being given with reference to the attached drawings, among which:

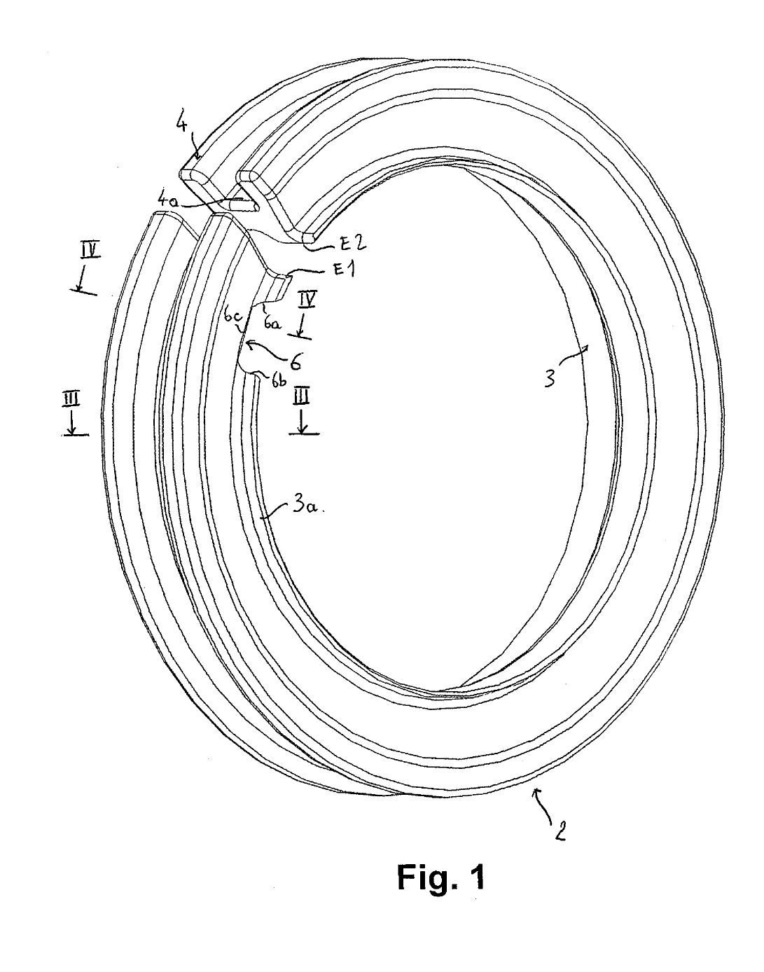

FIG. 1 is a perspective view of a ring included within a run-flat device according to one embodiment of the invention, showing a transverse notch formed in this ring,

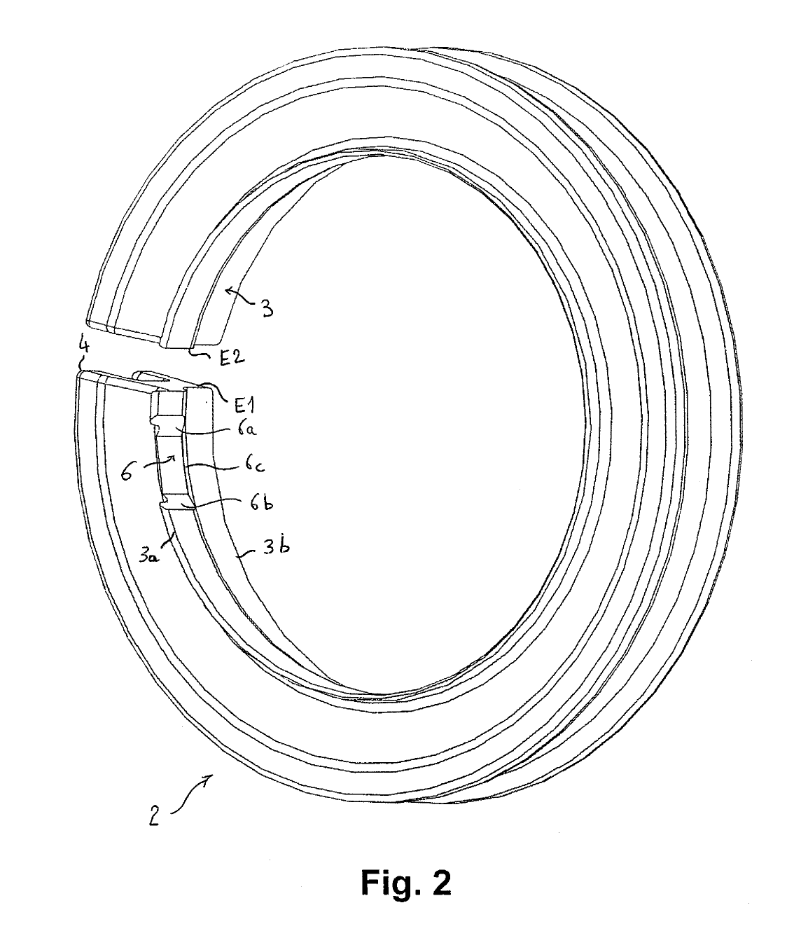

FIG. 2 is a perspective view of the ring according to the invention of FIG. 1 from another angle, showing the edges and the bottom of this notch from below,

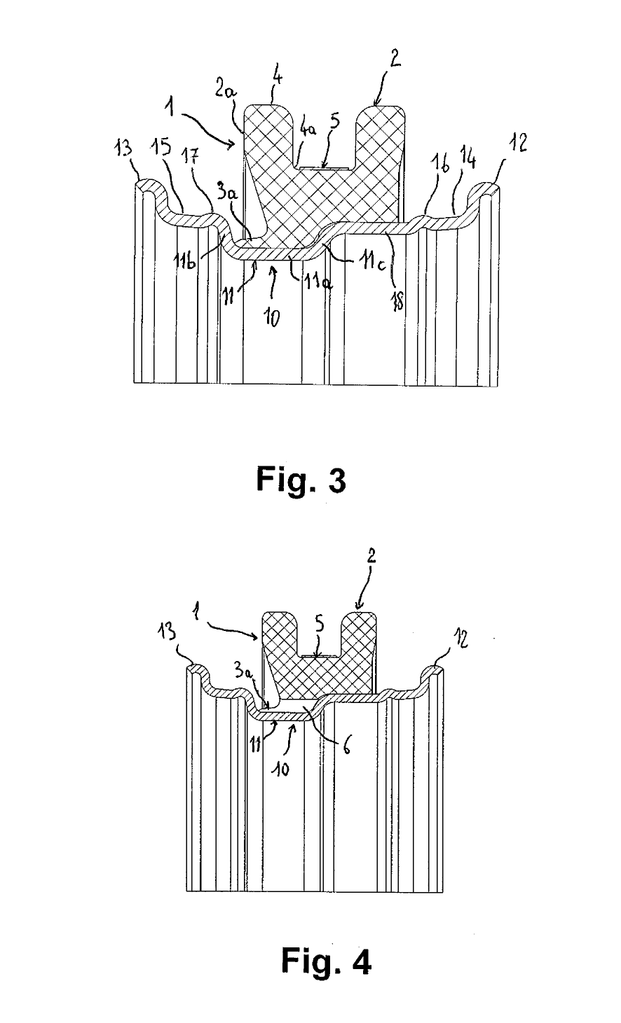

FIG. 3 is an axial half section on of FIG. 1 of a run-flat device according to the invention mounted on a one-piece rim and comprising the ring of this FIG. 1 and an annular clamping band applied to this ring,

FIG. 4 is an axial half section on IV-IV of FIG. 1 of the run-flat device according to FIG. 3 mounted on the same one-piece rim,

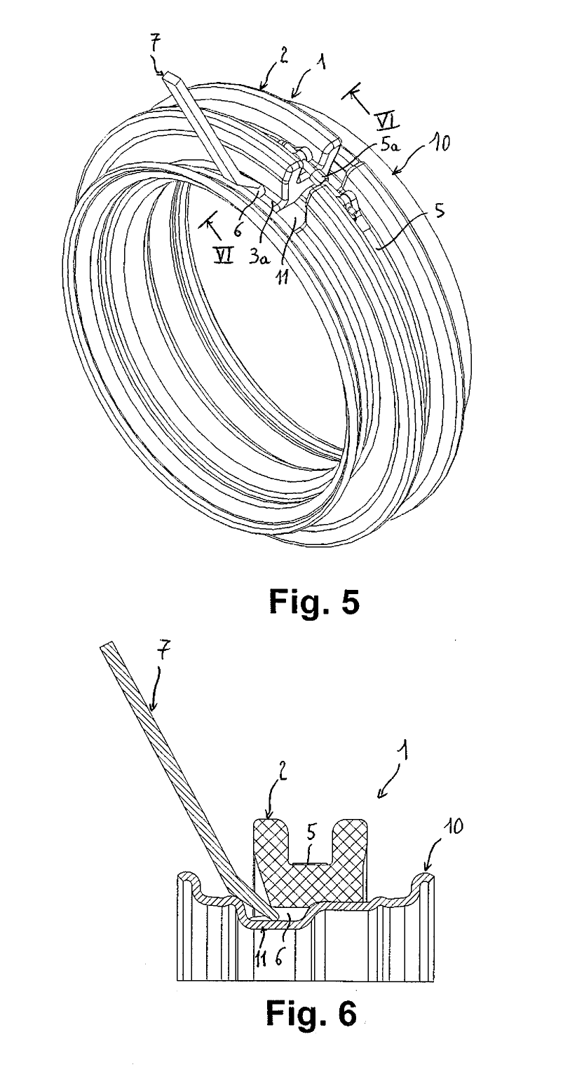

FIG. 5 is a perspective view of the run-flat device according to FIGS. 3 and 4 which is mounted on the same one-piece rim and which illustrates means of clamping and locking the band and the insertion of a lever between the rim and the ring via the notch in the latter,

FIG. 6 is an axial half section on VI-VI of FIG. 5 of this run-space device mounted on the rim with this lever inserted between the rim and the ring, and

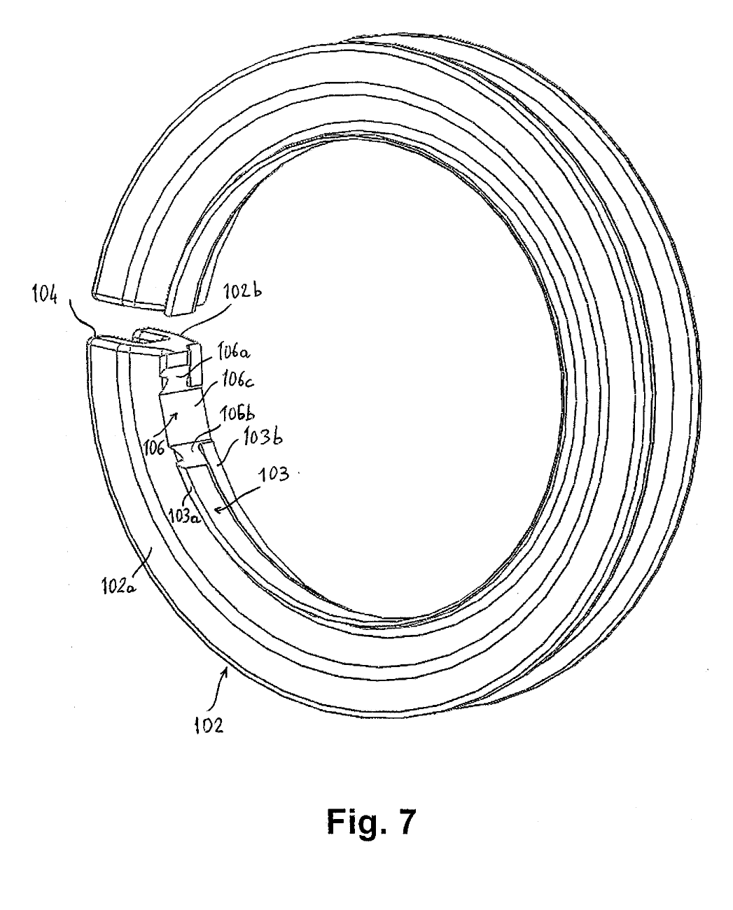

FIG. 7 is a perspective view of a ring included in a run-flat device according to a variant of the invention as compared with FIG. 2, showing from beneath, the edges and bottom of a transverse notch of another type which is formed in this ring.

In this description, the expressions “axially internal” and “axially external” refer respectively to those sides of the wheel rim that are intended to face toward the inside and toward the outside of the motor vehicle, and the expressions “radially internal” and “radially external” refer respectively to directions which are radial with respect to the rim and which get closer to and further away from the latter.

The run-flat device 1 illustrated in FIGS. 3 to 6 is mounted on an asymmetric wheel rim 10 of the one-piece type comprising a circumferential rim well 11, a tire (not illustrated) being mounted against axially internal and external flanges 12 and 13 of the rim 10.

The rim 10 comprises axially internal and external rim seats 14 and 15 intended respectively to accept beads of the tire, each rim seat 14, 15 being axially delimited by one of the flanges 12, 13 and, in the example of FIG. 1, by an adjacent circumferential hump 16, 17. In this exemplary embodiment, the rim well 11 is of the type with a flat bottom 11a and with substantially radial side walls 11b and 11c. More specifically, it may be seen from these FIGS. 3 to 6 that the side wall 11c adjacent to the internal seat 14 is connected to the latter by an axial bearing surface 18.

The device 1 essentially comprises a ring 2 designed to be positioned on the bottom 11a of the well 11 and in contact with its two side walls 11b and 11c via a radially internal mounting face 3 of the ring 2, and the latter is intended to support the tire following a drop in inflation pressure inside the mounted assembly via a radially external support face 4 of this ring 2.

As can be seen in FIGS. 1 and 2, the ring 2 is of one-piece structure made of an elastomer, plastic or composite, which in this exemplary embodiment is substantially in the shape of a U and is open (i.e. split by an axial slice) so that it has two circumferential ends E1 and E2 positioned facing one another.

This ring 2 essentially has:
the support face 4 in which there is formed a circumferential groove 4a which is defined by the base of the U, the depth of which is relatively great by comparison with the radial height of the ring 2 and which is surmounted by a clamping band 5 that clamps the ring 2 around the rim 10,
the mounting face 3 designed to espouse the axial profile of the well 11 via a circumferential axial lip 3a defining a lateral portion of this face 3, this lip 3a being capable of wedging the ring 2 in the rim well 11 and being formed to project axially with respect to the axially external lateral face 2a of the ring 2.

As illustrated in FIG. 3, this wedging lip 3a which is formed as a single piece with the remainder of the ring 2 is designed to be pressed both against the bottom 11a of the well 11 and against the two lateral walls 11b and 11c thereof. As for the remainder of the mounting face 3 of the ring 2, that has a surface that is flat overall and ends in a lateral portion 3b opposite the lip 3a and which is designed to be mounted in contact with the bearing surface 18 of the rim 10 adjacent to the well 11.

It may be seen in FIGS. 1 and 2 that the transverse notch 6 which is formed in this lip 3a has its two edges 6a and 6b running substantially in the axial direction, and its bottom 6c running substantially in the circumferential direction, it being emphasized that the notch 6 is wholly situated short of one of the ends E1 of the ring 2 and, in this preferential embodiment, in the immediate vicinity of this end E1. This notch 6 is thus substantially in the shape of a crenel, for example in the shape of an isosceles trapezium, of which the width of the bottom 6c that forms the short base of the trapezium corresponds substantially to that of the lever 7 that is to be inserted between the rim 10 and the mounting face 3 of the ring 2 (see FIG. 5). As illustrated in FIG. 2, this notch 6 is cut over the entire radial height of the lip 3a thus rendered discontinuous, which amounts to stating that each of the edges 6a, 6b of the notch 6 is two-dimensional.

As can be seen in FIGS. 3 to 6, the run-flat device 1 according to this embodiment of the invention comprises, by way of clamping band 5 that clamps the ring 2 around the rim 10, an open metal collar which is pressed firmly against the groove 4a and the facing ends of which are joined together by a connector system 5a with adjustable clamping tightness and which can be locked, for example by a screw engaging in journals, so as to bring the two ends E1 and E2 of the ring 2 close enough together.

In order to mount the run-flat device 1 in the corresponding mounted assembly, before the latter is inflated and balanced, the starting point is to insert the run-flat device 1 formed of the ring 2 fitted with the band 5 in the unclamped position inside the tire. A first bead of the tire containing this device 1 is then slipped onto the rim 10 before the ring 2 is tightened against the rim 10 using the connector system 5a.

During mounting, the mounted assembly is rotated about the axis of the rim 10 by a tire-fitting machine, so that the ring 2 can be levered over the rim flanges 12, 13 before becoming wedged in the rim well 11 via its mounting face 3. To this end, and in order to allow the ring 2 to rotate as one with the rim 10 and with the tire, the lever 7 is inserted between the well 11 and this ring 2 at the notch 6, and this has the effect of immobilizing the ring 2 against the rim 10. The final step of mounting involves slipping the second bead of the tire onto the rim 10.

In order to remove the run-flat device 1 from the rim 10, all that is required is for the lever 7 to be inserted under the same conditions in the notch 6 between the rim well 11 and the ring 2, which is easily levered over the corresponding rim flange 12, 13 and can easily be taken off the rim 10.

The ring 102 illustrated in the variant of FIG. 7 differs from that of FIG. 2 only in that the notch 106 it has in its radially internal mounting face 103 runs transversely over the entire axial width of this face 103, therein forming a recess that is both transverse and radial and common to the two lateral portions 103a and 103b of the ring 102 (i.e. to the notched lip 103a and to the opposite lateral portion 103b). Indeed FIG. 7 shows that the radial edges 106a and 106b of the notch 106—joined together by a bottom 106c—open onto the two side walls 102a and 102b of the ring 102, thus making the notch 106 an axial through-notch in relation to this ring.

Because of this increased axial width of the notch 106 by comparison with the notch 6, the insertion of the aforementioned lever provides even greater assistance with removing, from the rim 10, the device involving the ring 102 and the band 5 clamped by the connector system 5a.

In general, it will be noted that a run-flat device according to the invention, for example of the type with a ring 2 or 102, could comprise a clamping and locking connector system other than the system 5a illustrated in FIG. 5. For example, for such a connector system, use could be made of the system disclosed in patent application FR 0901520 in the name of the applicant company, i.e. one incorporated into a clamping band having a pair of ends spaced apart in the circumferential direction, means of coupling this pair of ends together with adjustable clamping in this direction, and a member for locking these coupling means. This band is such that the locking member is mounted secured to one of these ends so that it occupies an unlocked position in which it is free of these coupling means used to clamp and slacken off the band, and a locked position in which it engages with them so as to oppose this slackening-off.

These coupling means are able to move these ends closer together or further apart by a turn applied to these means in the direction for tightening or slackening off the band respectively, and the locking member is therefore designed to prevent these means from turning when they are in the locked position. These coupling means may comprise at least one cylindrical shank which at its respective end portions has two threads of opposite hand which are guided in their rotation in two first and second transverse journals which are fixed to the ends that are to be coupled, under the control of a member for turning the shank, rotating as one with a central portion thereof, it then being possible for the locking member to be pivot-mounted on the first journal so that in the locked position it butts against the operating member.

Advantageously, the locking member may then be formed of an articulated yoke having two cheeks which are pivot-mounted on said first journal, running laterally one on each side thereof, and which end in a locking section designed to fit closely around the operating member in the locked position so as to prevent it from turning. More advantageously still, this operating member may take the form of a nut with a number of flats, for example six flats, said locking section then potentially having a substantially inverted-U-shaped cross section designed to be mounted in contact with the operating member in the locked position, laterally via the flanges of the U and surmounting it by the web of this U.

1. A run flat device configured to be fitted to a tubeless mounted assembly for a motor vehicle which comprises a one piece wheel rim with a circumferential rim well and a tire mounted on the rim, the device being configured to support the tire following a drop of inflation pressure inside the mounted assembly, this device comprising a ring which has a mounting face that is radially internal to the device and configured to espouse the axial profile of the rim well, this mounting face having two lateral portions, the ring having an open structure with two ends held facing one another close together by ring clamping means, wherein at least one transverse notch, the two edges and bottom of which are located short of one of the ring ends, is formed in at least one of said lateral portions), which lateral portion(s) form(s) a circumferential notched lip that projects axially with respect to the corresponding side wall of the ring, that exhibits said at least one notch and that is configured to wedge the ring in the rim well, so as to allow a lever type tool to be inserted transversely via this notch between the rim and this mounting face to assist with the operations of mounting the device on the rim and/or removing it therefrom.

2. The run flat device as claimed in claim 1, wherein said edges of said or of each notch run substantially in the axial direction, and in that said bottom connecting these edges together runs substantially in the circumferential direction, so that the or each notch is substantially in the shape of a crenel, preferably a trapezoidal crenel.

3. The run flat device as claimed in claim 1, wherein said or each notch runs transversely over just part of the axial width of said radially internal mounting face so as at that location to form a recess that is both transverse and radial for only that lateral portion of the ring that forms said notched lip.

4. The run flat device as claimed in claim 1, wherein said or each notch runs transversely over the entire axial width of said radially internal mounting face so as at that location to form a recess that is both transverse and radial for each of the two lateral portions of the ring.

5. The run-flat device as claimed in claim 1, wherein said or at least one of said notches is situated in the immediate vicinity of one of the ends of the ring.

6. The run-flat device as claimed in claim 5, wherein said edge of that notch which is adjacent to one of the ends of the ring is separated from that end by a non nicked end section of said lateral portion which in the circumferential direction is of a length shorter than that of this notch.

7. The run-flat device as claimed in claim 1, wherein the ring is formed as a single piece, said at least one lip being crenellated by said or each notch and configured to wedge the ring in said rim well via its being mounted pressing against the side walls of this well.

8. The run-flat device as claimed in claim 7, wherein the ring has a radially external support face which is configured to support the tire under run-flat conditions, this ring being made of a plastic, elastomer or composite.

9. The run flat device as claimed in claim 8, wherein the ring exhibits at least one circumferential radial indentation, and in that said ring clamping means comprise at least one annular clamping band which circumferentially encircles the ring at this indentation, and which is provided with a clamping and locking connector system, so as to bring said ring ends closer to one another and keep the ring substantially in contact with the rim under running conditions.

10. The run flat device as claimed in claim 9, wherein, when viewed in axial section, the ring is substantially in the shape of a U defining said indentation in the form of a groove accommodating said clamping band, which comprises a metal collar which is clamped and locked preferably by a screw mounted in journals.

11. A tubeless mounted assembly for a motor vehicle, comprising a one piece wheel rim with a circumferential rim well, a tire mounted against axially internal and external flanges of the rim and a run-flat device mounted on the rim and configured to support the tire following a drop in inflation pressure inside the mounted assembly, wherein the device is as defined in claim 1.

12. The mounted assembly as claimed in claim 11, wherein said radially internal mounting face of the ring is mounted pressing against this rim well via said circumferential lip forming lateral portion crenellated by said or each notch.

13. A method of mounting a run flat device as claimed in claim 1 on a one piece wheel rim with two, axially internal and external, flanges and/or of removing it therefrom, wherein the method involves inserting a lever type tool radially between said rim well and said radially internal mounting face of the ring at the location of said or of at least one of said notch(es):
when mounting the device and the surrounding tire on the rim in order, thanks to this tool inserted in this way, to immobilize this device on the rim so as to lever it over the rim flanges and ensure that it rotates as one with the rim and with the tire in this rim well when a machine for assembling the mounted assembly is turning it about the axis of the rim; and/or
when the device is being removed from the rim so as, thanks to this tool inserted in this way, to assist with extracting the device from the rim well and with levering it beyond the corresponding rim flange to make it easier to take it off the rim.
